(19) United States
(12) Patent Application Publication
(10) Pub. No.: US 2005/0171760 A1
(43) Pub. Date: Aug. 4, 2005

(54) Visual thesaurus

(76) Inventor: Marc Tinkler, New Brunswick, NJ (US)

Correspondence Address: KENYON & KENYON;attn: Jeffrey Ginsberg, One Broadway, New York, NY, 10004, US

(21) Appl. No.: 10/962,245

(22) Filed: Oct. 8, 2004

Related U.S. Application Data
(60) Provisional application No. 60/509,705, filed on Oct. 8, 2003.

(51) Int. Cl. G06F 17/21

(52) U.S. Cl. 704/10

(57) ABSTRACT

A visual thesaurus system and method for displaying a selected term in association with its one or more meanings, other words to which it is related, and further relationship information. The results of a search are presented in a directed graph that provides more information than an ordered list. When a user selects one of the results, the display reorganizes around the user's search allowing for further searches, without the interruption of going to additional pages.

### CROSS-REFERENCE TO RELATED APPLICATIONS

The present application claims the benefit under 35 U.S.C. § 119(e) of U.S. Provisional Patent Application Ser. No. 60/509,705 entitled “Visual Reference System”, filed in the U.S. Patent and Trademark Office on Oct. 8, 2003, hereby incorporated by reference in its entirety. The present application also relates to U.S. patent application Ser. No. 09/828,931 entitled “System For Creation Of Visual Representation Of Data”, filed Apr. 6, 2001, which is also hereby incorporated by reference in its entirety.

### FIELD OF INVENTION

This invention relates to a visual reference system for accessing stored information. More specifically, this invention relates to a visual thesaurus reference system (hereinafter “visual thesaurus system”) which allows visual display of relationships between related words and their respective meanings, and in particular, displays a word in association with multiple meanings, or senses, the word may have.

### BACKGROUND OF INVENTION

Traditional print reference guides often have two methods of finding information: an order (alphabetical for dictionaries and encyclopedias, by subject hierarchy in the case of thesauri) and indices (ordered lists, with a more complete listing of words and concepts, which refers back to original content from the main body of the book). A user of such traditional print reference guides who is looking for information will either browse through the ordered information in the main body of the reference book, or scan through the indices to find what is necessary.

The advent of the computer allows for much more rapid electronic searches of the same information, and for multiple layers of indices. Users can either search through information by entering a keyword, or users can browse through the information through an outline index, which represents the information contained in the main body of the data. There are two traditional user interfaces for such applications. First, the user may type text into a search field and in response, a list of results is returned to the user. The user then selects a returned entry and may page through the resulting information. Alternatively, the user may choose from a list of words from an index.

For example, software thesaurus applications, in which a user attempts to find synonyms, antonyms, homonyms, etc. for a selected word, are usually implemented using the conventional search and presentation techniques discussed above. The presentation of results only allows for a one-dimensional order of data at any one time. In addition, only a limited number of results can be shown at once, and selecting a result inevitably leads to another page—if the result is not satisfactory, the users must search again. Finally, it is difficult to present information about the manner in which the search results are related, or to present quantitative information about the results without causing confusion.

Therefore, there exists a need for a multidimensional graphical display of information, in particular with respect to information relating to the meaning of words and their relationships to other words. There further exists a need to present large amounts of information in a way that can be manipulated by the user, without the user losing his place. And there exists a need for more fluid, intuitive and powerful thesaurus functionality that invites the exploration of language.

### SUMMARY OF THE INVENTION

To meet the needs described above, the present invention provides a visual thesaurus system that includes: source means for obtaining information concerning a plurality of words, meanings and relationships between the words and meanings; graphing means for determining a set of word, meaning and relationship information to be displayed in a directed graph related to a selected word from the plurality of words, meanings and relationship obtained by the source means; positioning means for determining a relative position of the related words, meanings and relationships in the set of information to be displayed; and displaying means for determining a represent of the related words, meanings and relationships in the set of information on a display. The selected word may have a plurality of meanings and all of the meanings of the selected word are displayed.

### BRIEF DESCRIPTION OF DRAWINGS

FIG. 1 is a block diagram of a system which supports the visual thesaurus system according to an embodiment of the present invention.

FIG. 2 is an example display of a selected word (“train”) surrounded by a plurality of its different senses according to the present invention.

FIG. 3A is an example display of a synset obtained using one of the senses of the example word “train” according to the present invention.

FIG. 3B illustrates the synset of FIG. 3A with a pop-up definition of one of the terms in the synset (“groom”).

FIG. 4A is an example display of an alternate sense of the word “train” mapped with related meanings.

FIG. 4B shows magnified views of specific relationships between terms depicted in FIG. 4A.

FIG. 5 is an example display showing the Narrower Terms Compass in the lower right corner.

FIGS. 6A to 6K illustrate example relationships that may be displayed in the visual thesaurus according to the present invention.

FIG. 7 illustrates a screen shot including lists of meanings of a selected word categorized according to different parts of speech.

FIG. 8 illustrates a screen shoot depicting a three-dimensional view of the visual thesaurus directed graph display according to the present invention.

FIG. 9 illustrates an exemplary organization of a programming object for generating a visual thesaurus directed graph display according to the present invention.

### DETAILED DESCRIPTION

The present invention provides a visual thesaurus system and method which provides a fluid, intuitive and powerful method for displaying a selected word (or term) in association with its one or more meanings and other words to which it is related. The results of a search are presented in a directed graph that provides more information than an ordered list. When a user selects one of the results, the display reorganizes around the user's search allowing for further searches, without the interruption of going to additional pages. This reorganization is depicted on the screen as a smooth animated movement that is easy to follow with the eye.

Each of the objects depicted by the depicted graph of the visual thesaurus system is termed an ‘entity’, which is defined herein as a piece of information that has one or more properties. The depicted entities are divided into two classes, nodes and edges. Pieces of information that are discrete, such as words, or particular meanings of words, are classified as node entities, while information that characterizes relationships between the words and meanings, i.e., information that deals with connections between two or more nodes, are classified as edge entities. Both the nodes and edges have properties. A property of a meaning, for example, is its part of speech, or a sample sentence that explains how it is used. A property of a relationship is its type, for example, a synonym relationship, or an antonym relationship.

The visual thesaurus system of the present invention provides a convenient user interface to manipulate and explore the words, meanings and relationships presented in the display. For example, when a word is clicked, the word moves from a first position to a position in the center of the screen, and the word is connected to other meanings which are in turn connected to words. These meanings are also represented in list form on the side of the screen. This differentiation between words and meanings and relationships allows for a more complete understanding of the various meanings of a word that is in the center. Words that are connected through any one meaning share that particular meaning.

Clicking on a meaning (one of the small circles or the meanings listed on the right of the screen) is the equivalent of a search through the data. This particular embodiment of the invention treats different types of relationships in a different manner. If the relationship has a direction (a “tread” is part of a “tire,” for example), it is treated differently than if it does not.

The relationships can be treated differently, either through color, shape or behavior. For example, the relationships between meanings may be depicted differently (dotted lines) from the relationships between words (solid lines). For example, antonyms may be depicted by a red dotted line.

Rolling over an entity with a mouse or other pointing device results in more information being displayed. The rolling over of an entity causes similar actions on other areas of the screen (if a meaning is depicted on the directed graph and also on the pane to the right, rolling over the meaning on either side results in a similar action on the other representation of the meaning.)

There is a history that represents previous searches. The user can select items in the history to go recreate previous searches. By selecting an item from the history, the display returns to a previous state.

The display can be represented in both two and three-dimensional modes. In a three-dimensional mode, the entire directed graph can be rotated. The user can look at one part of the display and then rotate it to see another. This manipulation of the graph allows for the presentation of a much larger data set than a two dimensional display. The rotation allows for the presentation of more complex relationships because of the use of three-dimensional space to uncover relationships.

The user can enable and disable different relationship types. By making a selection, the user changes the results immediately. For example, a user may not want to see verbs. By de-selecting verbs, only nouns become available.

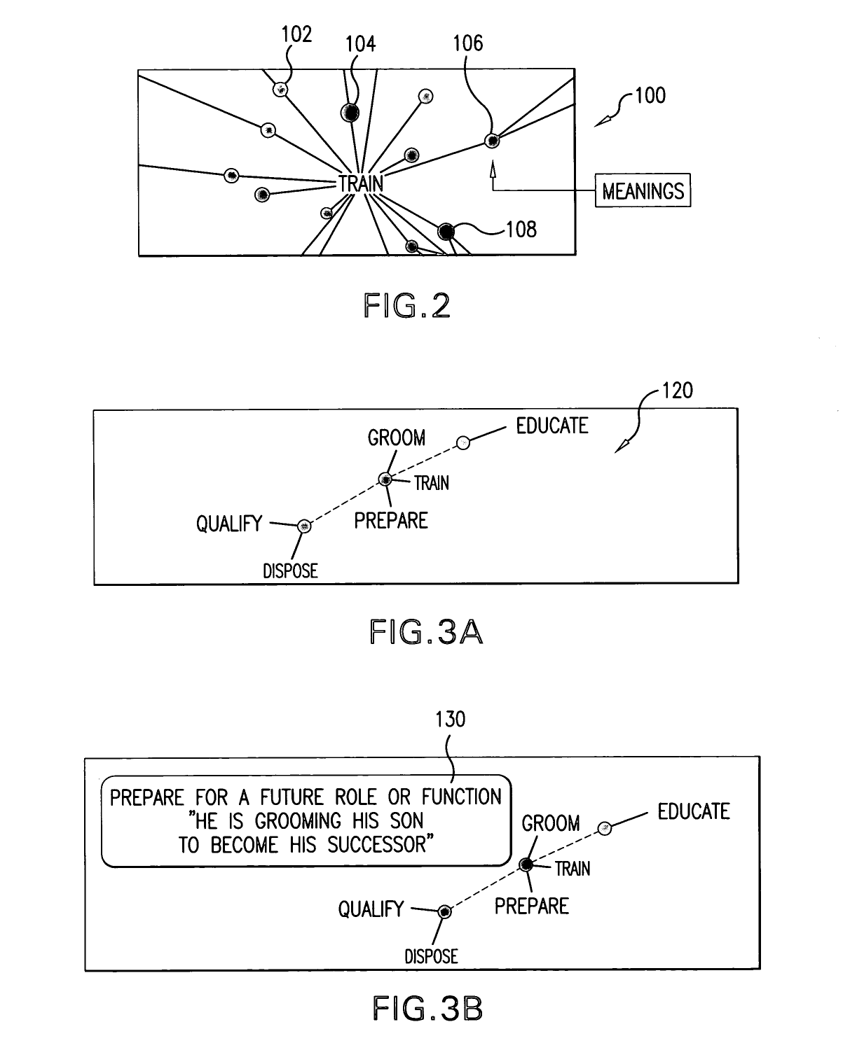

Many words (and multi-word terms) have multiple meanings (also referred to as ‘senses’). The word “train”, for instance, has several different meanings; for example, it can mean “to prepare for a future task or career” (a verb), and it also can mean “a line of railway cars coupled together” (a noun). As can be discerned from these two quite distinct meanings, the word “train” is not in itself a noun or verb, but rather, it is the individual meanings of “train” that can be classified as a particular part of speech. FIG. 2 illustrates an example screen display 100 of the visual thesaurus in which the word train is surrounded by its various meanings, e.g., 102, 104, 106, 108. As shown, the meanings are symbolically represented as circles. Meanings classified in different parts of speech may be given different colors or sizes. For example, noun meanings may be depicted as red circles, adjectives as yellow circles, while verbs and adverbs may be depicted as green and blue circles, respectively.

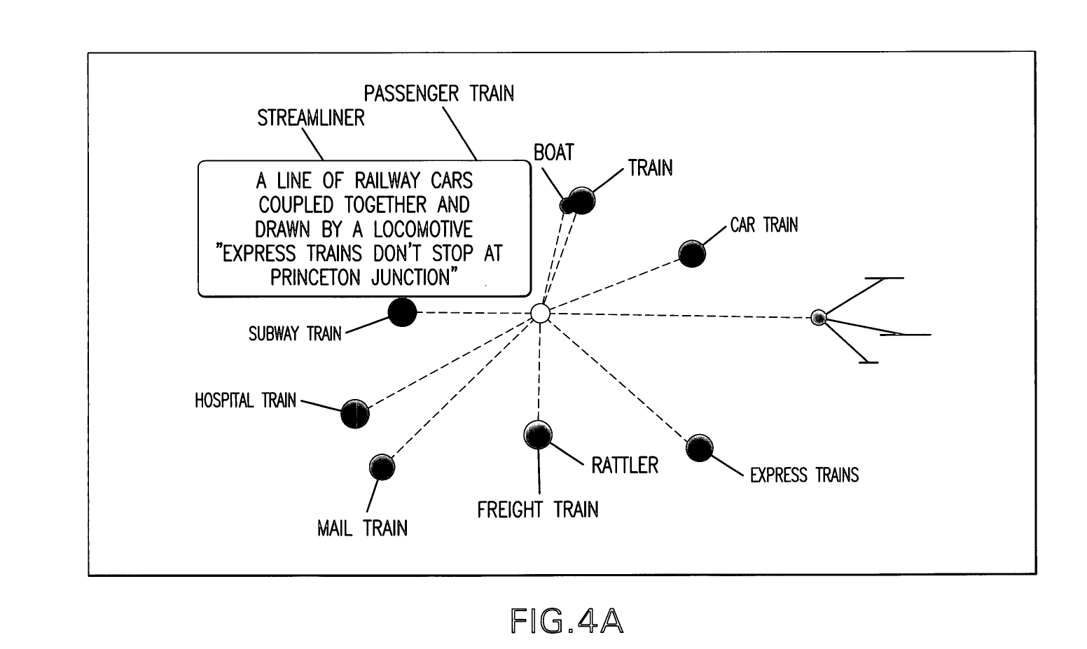

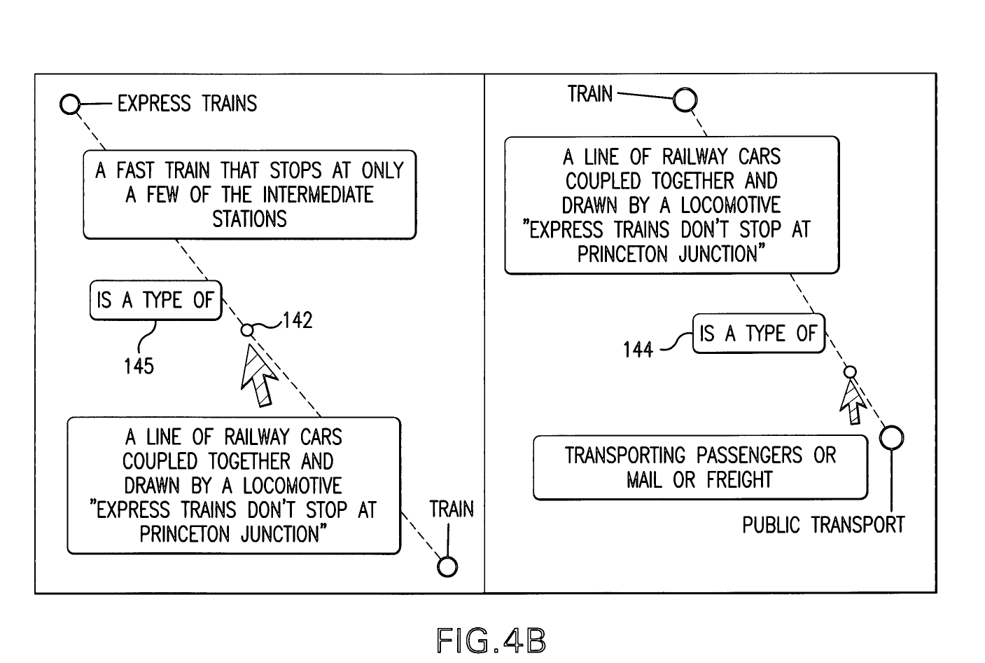

As a word can have meanings, a meaning, or sense, can conversely be expressed using multiple words. According to the example above, the term “to prepare for a future task or career” can be expressed not only using the word “train”, but also using such additional words as “prepare”, “educate” and “develop”. These words that are associated with the same meaning are synonyms and can be grouped in a single set referred to as a “synset”. A synset 120 for the verb meaning of train is shown in FIG. 3A. As shown, the words that belong to the same synset are connected using lines, such as solid lines. The program interface of the visual interface enables visual navigation of the synset, whereby if a user rolls over a meaning, the words that constitute the system may be highlighted, and the particular definition of the meaning 130 may be displayed with example phrases as shown in FIG. 3B.

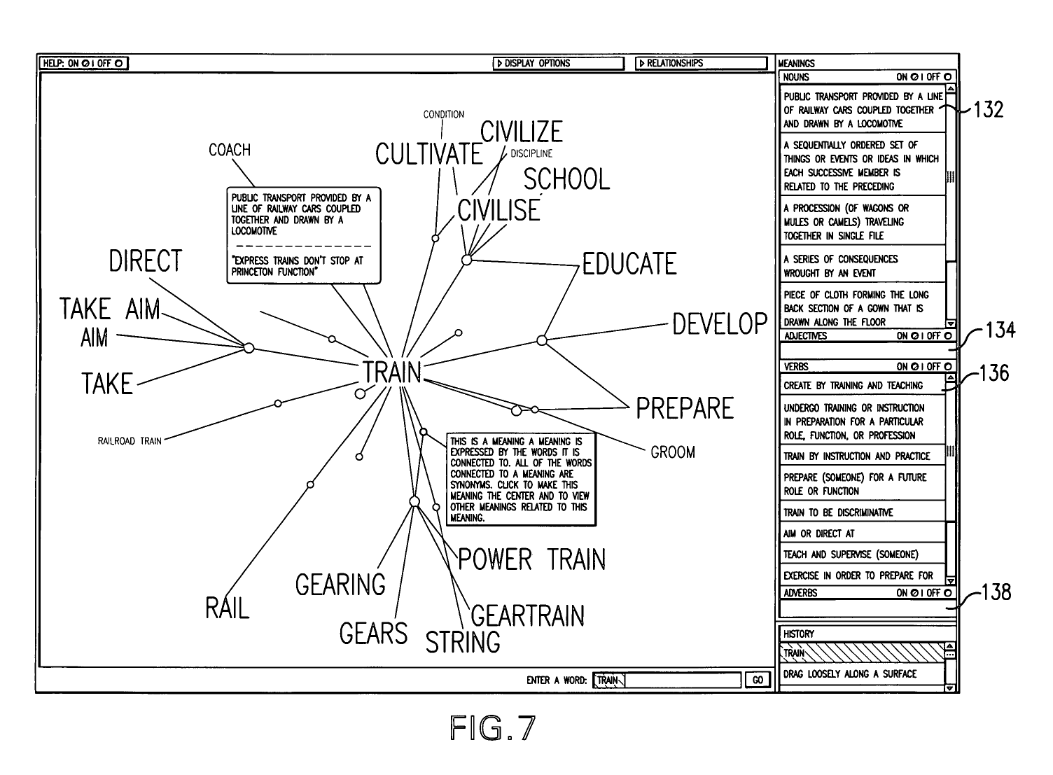

Additionally, meanings are also presented in four lists 132, 134, 136, 138 (one for each part of speech) on the right hand side of the program interface (see FIG. 7). The lists present the definition of each meaning. Clicking or moving the cursor over items in the list produces the same result as moving the cursor over the equivalent node within the main display. The user can turn off any of the lists, which has the effect of hiding meanings of the associated particular parts of speech within the display.

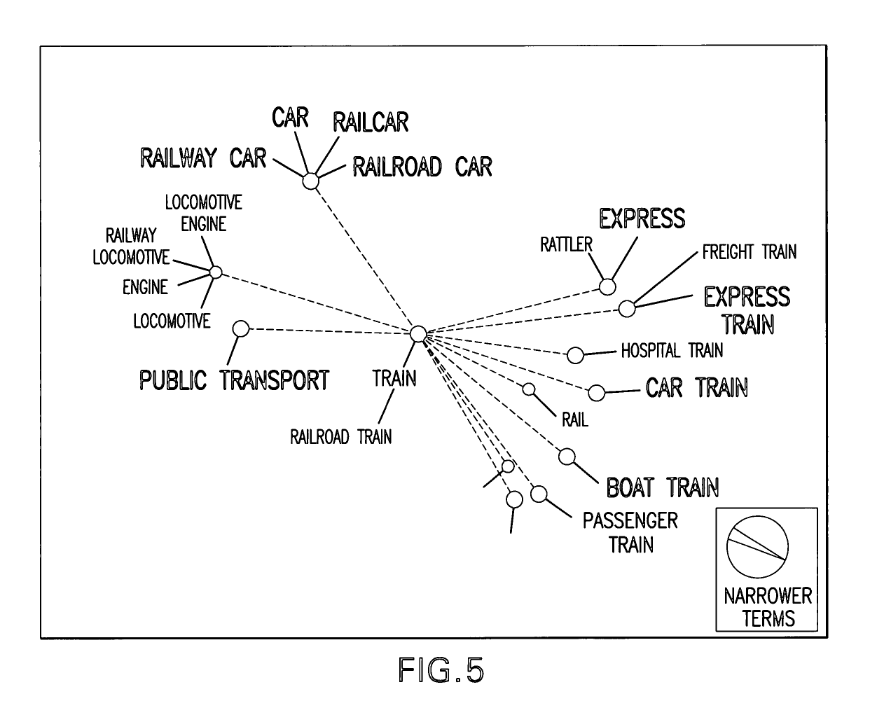

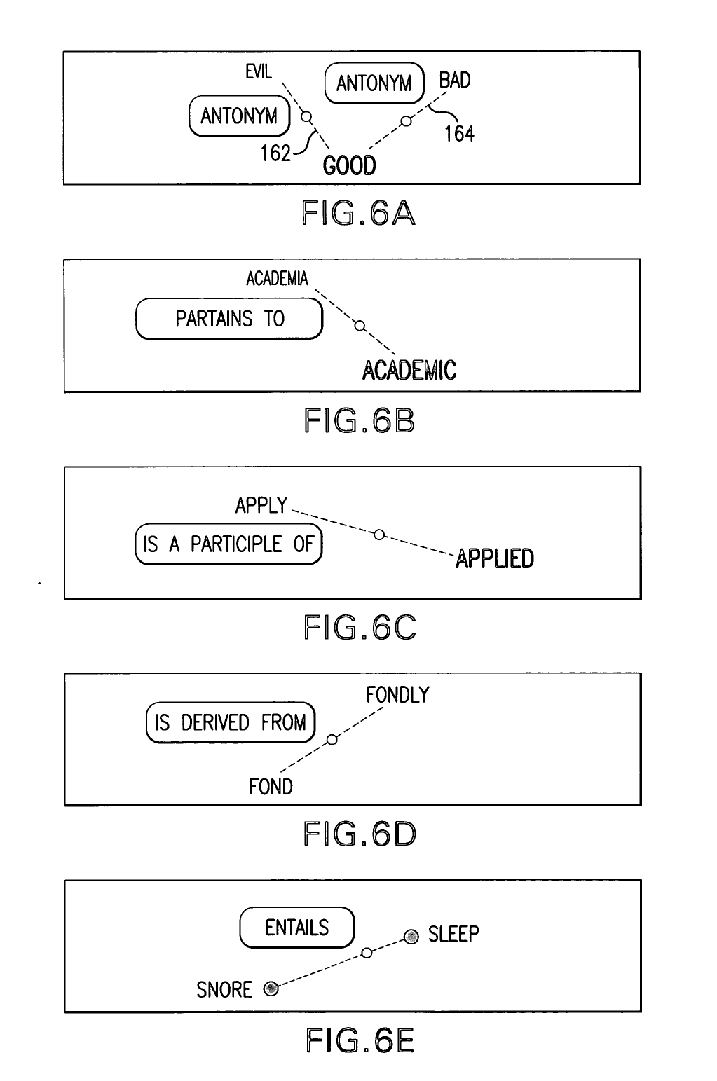

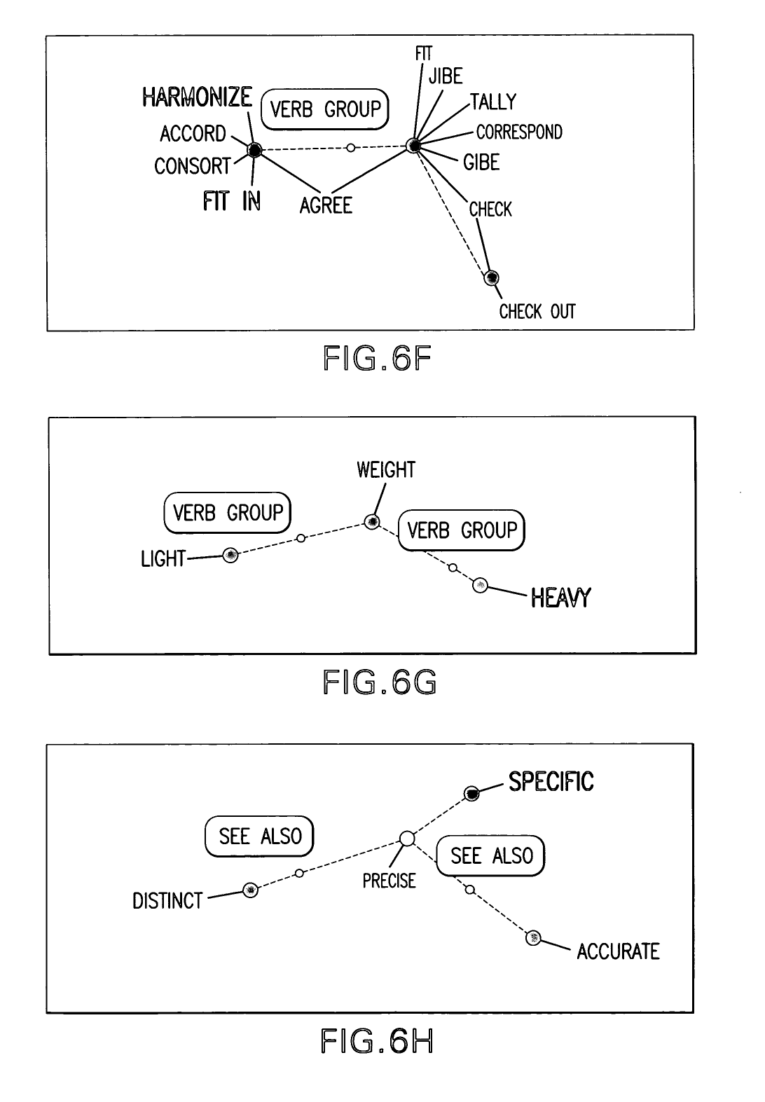

Advantageously, the visual thesaurus system of the present invention can display additional relationships between words and meanings and can also visually represent and reveal the relationships. For example, by clicking on the meaning (in FIG. 2) of “a line of railway cars coupled together” this meaning 140 appears with “train” at the center of the screen mapped with related meanings as shown in FIG. 4A. Relationships between meanings are displayed as dashed lines. For example, as shown in the sectional views in FIG. 4B, the line 142 connecting “express train” defined as “a fast train that only stops at a few stations” to “train” defined as “a line of railway cars” is classified as a “is a type of” relation since an express train is a type of train. Navigating the cursor over the relationship line causes the type of relationship “is a type of” 145 to appear in the display. Similarly, the dashed line 144 connecting “train” to “public transport” is also an “is a type of” relationship since a train is a type of public transport. In this manner, the selected definition at the center of the display exists in a contextual continuum of terms and meanings, some of which are narrower (such as “express train”) and others of which are broader (such as “public transport”). As shown in FIG. 5, the program interface may include a Narrower Terms Compass which appears in the lower right corner of the display whenever broader or narrower terms are displayed, and points in the direction of narrower terms.

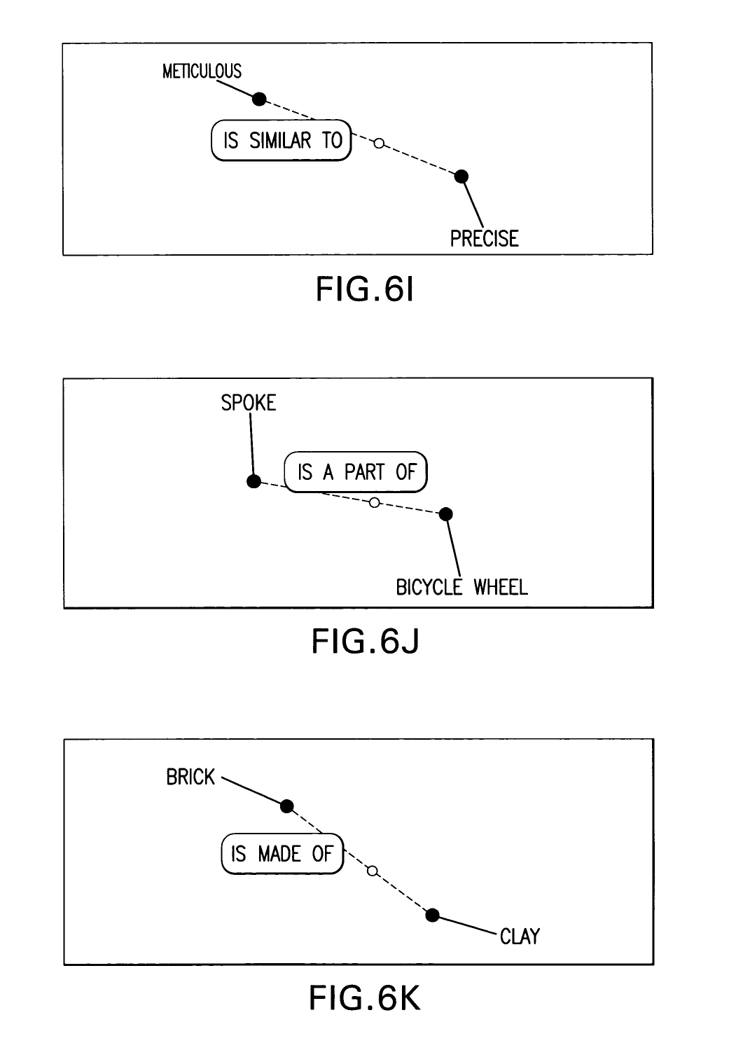

The “is a type oP” relationship is only one of numerous categories of sense relationships that can be displayed according to the present invention. FIGS. 6A-6K depict examples of these different relationships. FIG. 6A depicts antonym (opposite meaning) relationships between the selected word good and the antonym words evil and bad. As can be discerned, the dashed lines 162, 164 connecting good with evil and bad are identified as antonym relationships. FIG. 6B depicts a “pertains to” relationship between the terms “academia” and “academic”. FIG. 6C depicts a “participle of” relationship between the terms “apply” and “applied”. FIG. 6D depicts a “derived from” relationship, which indicates an adverb derived from a verb participle, between the terms “fondly” and “fond”. FIG. 6E depicts an “entails” relationship. A verb X is said to entail Y if X cannot be done unless Y is, or has been done. Thus, in the depicted example, one cannot snore (X) unless one is sleeping (Y). FIG. 6F depicts a verb group which share related meanings but may not be considered synonyms. FIG. 6G depicts attribute relationships where the noun “weight” is an attribute, and the terms “heavy” and “light” represent values of the attribute. FIG. 6H depicts “see-also” relationships in which the displayed meanings have different senses but express related concepts. In the depicted example, distinct, specific, and accurate are all related to the word “precise”, but each of these words has a meaning non-synonymous with precise. FIG. 6I depicts an “is similar to” relationship between the term “meticulous” and “precise”. FIG. 6J depicts an “is a part of” relationship between “spoke” and “bicycle wheel” and FIG. 6K depicts an “is made of” relationship between “brick” and “clay”.

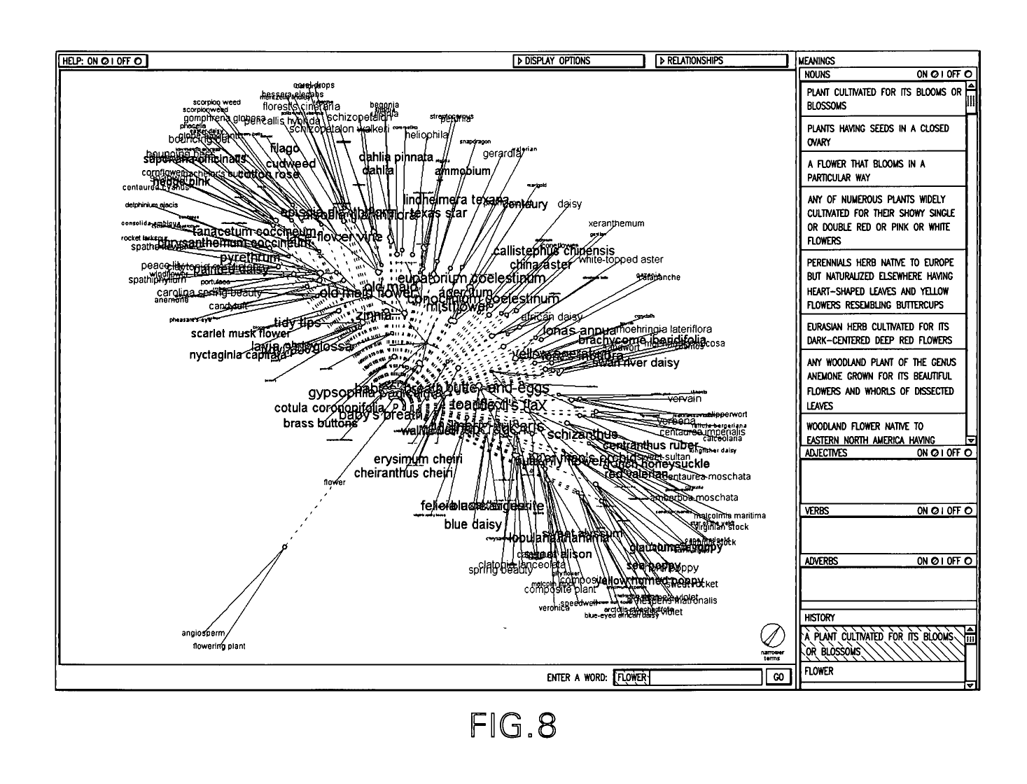

Any display can be filtered so as to display only a portion of the total set of sense relationships. In addition, the display mode can be switched between a two-dimensional view and a three-dimensional rotatable view. An example three-dimensional view is depicted in FIG. 8.

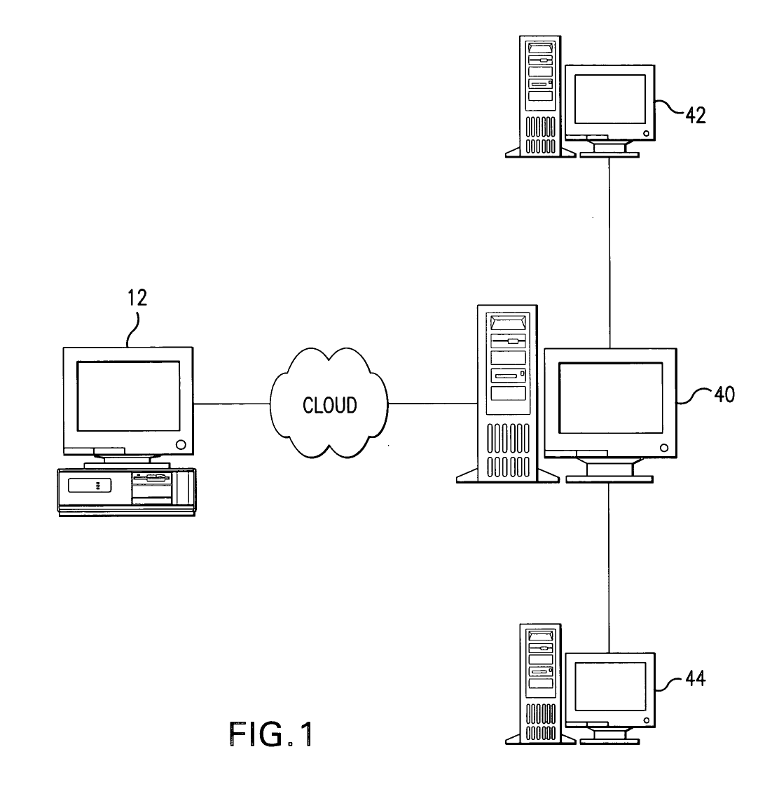

FIG. 1 is a block diagram of an exemplary system 10 in (and through) which the visual thesaurus system of the present invention may be implemented. As will be described further below, the visual thesaurus system may be implemented using one or more computer-executable software programs and associated reference data. The reference data from which the visual thesaurus directed graph is constructed (including word, meaning and relationship information) may either be stored locally using a CD-ROM or other storage media (“stand alone version”), or may be distributed from a remote server. In the stand alone version, the data stored on the local storage media may include the word, meaning and relationship data needed to generate a visual thesaurus display as described above.

In the online version, the reference data is not stored locally, but rather, a client computer 12 is coupled to the Internet to receive such reference data from a web server 40. The client 12 executes an application programming interface (described in greater detail below) to generate the visual thesaurus system and sends requests for reference data to the web server 40. The web server 40 includes server software adapted to respond to requests from the client 12; the web server 40 may store the reference data locally or it may be coupled to one or more distributed web-based data sources from which it can obtain the data according to methods well known in the art.

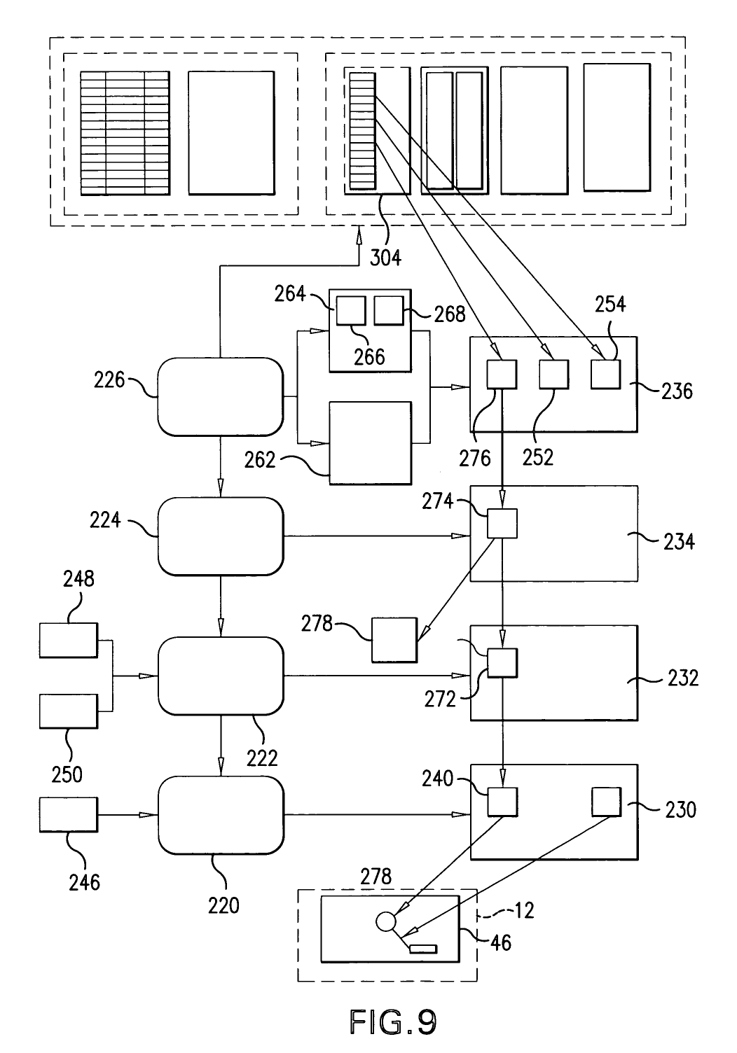

An exemplary software mechanism for generating the visual thesaurus display for user-selected words is described with reference to FIG. 9. The present invention employs the ThinkMap application platform, commonly owned and sold by the assignee, to assemble and generate the visual thesaurus. By way of reference, a complete description of the Thinkmap platform is given in U.S. patent application Ser. No. 09/828,931 entitled “System For Creation Of Visual Representation Of Data”, incorporated by reference above. It is noted, however, that the visual thesaurus system of the present invention should not be limited thereby, as it may be implemented using other platforms and/or software techniques available to those of skill in the art.

FIG. 9 shows an exemplary organization of an application programming object that may be delivered by an application server program to the client computer to generate the visual thesaurus and the corresponding display. The programming object includes three main components: entities, managers and properties. As noted above, entities are a generic term for objects which contain a set of different properties and are used to represent data for display. For example, words, meanings and relationships are entities. Managers are programming objects which create, destroy and manage entities. Properties are characteristics of entities which are requested and provided from entities, managers or data sources.

According to an example embodiment, there are four kinds of managers: a display manager 220, a position manager 222, a graph manager and a source manager 226. Each manager handles a different type of class of entity: the display manager handles display entities 230, the position manager 222 handles position entities 232, the graph manager handles graph entities 234 and the source manager 226 handles source entities 236.

The four types of entities have different functions in the representation of data from the data source, which may include one or more online or local database resources such as online dictionaries, relational tables, etc. The display entities 230 determine the presentation and position of the word, meaning and relationship data on the display screen. The position entities 232 determine the position of the data in global space relative to each other. The graph entities 234 determine potential data that may be displayed, and the source entities determine that data that may be derived from the one or more data sources.

As shown in FIG. 9, the managers 220-226 are arranged in parent/child relationships. According to this arrangement, an entity handled by the parent manager is the parent of an entity handled by the child manager. For example, a entity handled by the position manager 222 is the parent of an entity handled by the display manager 220.

More specifically, the display manager 220 uses different display entities which draw screen objects in different ways to complete the display. For example, a display entity such as the display entity 240 may cause a circle to be rendered to represent the meaning of a word. A display entity such as display entity 242 may define a dashed line to represent a relationship between words or meanings. In addition to rendering a number of different display entities, the display manager 220 also manages display options including the number of dimensions of the display, background, scale and origin.

The position manager 222 creates and manages position entities 232 which map entities in global space as opposed to the screen space shown on screen. A position entity has properties that allow the programming object to position and move it in three-dimensional global space. The position manager 222 enables layout and “information” modules (an informotion module is defined herein as an algorithm for translating information into motion and that acts on position entities) to be used which determine the position of the entities in global space and which provide motion to the position entities, respectively. An example information module determines the position and motion of the position entities according to a “physical law” algorithm whereby the position entities move as if they have a magnetic repulsion with respect to one another, and the edges between them have an elasticity. The combination of the modules thereby determine a moving layout of the position entities.

The graph manager 224 creates and manages graph entities and determines the potential connectedness and relationship of possible entities for the representation on the display by traversing potentially related entities given constraints that are determined by user's choices entered in the interface. For example, if the user is interested only in verb and adverb words and meanings in a given display, the graph manager traverses the entire potential set of related words and meanings and removes nouns and adjectives from the set of words and meanings that are to be graphed. The graph manager 224 obtains the potentially related entities from the source manager 226 and the graph manager 224 examines the collected entities using a center entity as the starting point and visiting all the graph entities which may be related to the center entity.

The source manager interfaces with the one or more data sources and provides the programming object with a virtual view of the data sources. Because the programming object may not be able to load the entire contents of a data source to the client computer, the source manager 226 is used to dynamically load the data on demand. When the programming object requires a data item from a data source, it instructs the source manager 226 to obtain it, and the source manager 226 constructs a source entity such as source entities 252 and 254 to represent items such as in data table 304.

Through use of the above-described programming object, a word can be displayed in an ordered arrangement in association with its meanings (senses) and a plurality of words to which it is related in one way or another.

What makes the display of the visual thesaurus system more useful than previous models of reference search results is the additional information that is given about the results. The display gives more information than a mere presentation of the links or relationships between different entities. Each type of result is presented differently, allowing for the user to differentiate between meanings and words, for example, or other types of reference material. The user can dynamically filter results, eliminating those that do not meet the user's criteria.

In addition, different types of relationships between entities are treated in different ways, allowing for the user to more completely understand the intricacies of the search results. The user can choose which types of relationships are the most relevant, and see a change in the directed graph in real time. Different types of relationships are presented in a different manner. Those that lend themselves to a hierarchical display are presented hierarchically, with more specific terms to one direction. Those that do not have a hierarchical structure are presented in a graph that does not show hierarchy.

The visual thesaurus system also encompasses the display of qualitative and quantitative information on one graphical user interface. Each result can also have a quantitative component (how many, how often, etc) that can be mapped into the display as either size (the distance of the lines, or the size of the circles), or movement (the rapidity with which an element moves; the perceived weight of an element).

The visual thesaurus system describes a correlation between the novel graphical user interface and the more traditional list form. As users manipulate the graphical user interface described above, it immediately changes the presentation of results in an accompanying traditional display.

The manner in which the graphical user interface moves allows for a more fluid navigation through concepts. When a result is selected, it may move first quickly and then more gradually into place in the center of the screen, allowing the user to more easily track the movement with the eye. As new results are returned from the database, they may move into place in the same rapid-to-gradual process. The user can rotate the three-dimensional display without altering the essential form of the diagram. The end result is a presentation of search results that not only helps users find the result they are looking for, but also allows for an intuitive exploration of the resulting information. This graphical user interface becomes an alternative method of navigating among reference topics, whether they be words, images, encyclopedia entries, or dictionary definitions.

It will be apparent to those skilled in the art that various modifications and variations can be made in the method and system of the present invention without departing from the spirit or scope of the invention. Thus, the present invention is not limited by the foregoing descriptions but is intended to cover all modifications and variations that come within the scope of the spirit of the invention and the claims that follow.

1. A visual thesaurus system, comprising:
source means for obtaining information concerning a plurality of words, meanings and relationships between the words and meanings;
graphing means for determining a set of word, meaning and relationship information to be displayed in a directed graph related to a selected word from the plurality of words, meanings and relationship obtained by the source means;
positioning means for determining a relative position of the related words, meanings and relationships in the set of information to be displayed; and
displaying means for determining a representation of the related words, meanings and relationships in the set of information on a display;
wherein the selected word may have a plurality of meanings and each of the meanings of the selected word are displayed by the displaying means.

2. The visual thesaurus system of claim 1, wherein the plurality of meanings of the selected word are displayed as a node in the display.

3. The visual thesaurus system of claim 2, wherein selecting any of the nodes of the meanings of the selected word causes an associated definition to be displayed and triggers generation of a new directed graph corresponding to the selected meaning.

4. The visual thesaurus system of claim 1, wherein synonyms of each the plurality of different meanings of the selected word are displayed.

5. The visual thesaurus of claim 2, wherein the nodes are color coded according to a part of speech of the corresponding meanings.

6. The visual thesaurus system of claim 2, wherein the displaying means displays listings of the meanings of the selected word categorized by part of speech.

7. The visual thesaurus system of claim 1, wherein the positioning means imparts motion to the words, meanings and relationships using an informotion module.

8. The visual thesaurus system of claim 7, wherein the information module imparts motion according to a physical law mechanism that simulates effects of magnetism and elasticity.

9. A method of providing a visual thesaurus, the method comprising:
receiving a selected term;
obtaining word, meaning and relationship information regarding the selected term;
displaying information including a plurality of meanings of the word connected to the selected term in a directed graph;
wherein the plurality of meanings are depicted as nodes and the selected term is positioned in the center of the directed graph.

10. The method of claim 9, further comprising:
displaying synonyms of each the plurality of different meanings of the selected word connected to the respective nodes.

11. The method of claim 9, wherein each of the nodes are color coded according to a part of speech of the meaning of the nodes.

12. The method of claim 9, further comprising:
displaying the directed graph in three-dimensional format.

13. The method of claim 9, further comprising:
displaying terms related to the selected term and corresponding relationship information.

14. The method of claim 9, further comprising:
displaying listings of the plurality of meanings of the selected term categorized by parts of speech.

15. The method of claim 9, further comprising:
imparting motion to the displayed information.

16. The method of claim 9, wherein motion is imparted to the displayed information according to a physical law mechanism that simulates effects of magnetism and elasticity.

17. The method of claim 9, wherein the display entities include terms in a plurality of different languages.

18. A method of providing a visual thesaurus comprising:
displaying a first level of information including a word and a plurality of meanings of the word;
displaying at least one further level of information including terms related to at least a portion of the plurality of meanings of the word.

19. The method of claim 18, further comprising:
displaying relationships between the further level of information and the first level of information.

20. The method of claim 19, wherein the relationships may be one of a: synonym, antonym, type of, pertains to, participle of, derived from, part of, made of, attribute, entails, verb group, see-also, and is similar to.

21. The method of claim 18, wherein the further level of information includes terms of a plurality of different languages.
